(19) United States
(12) Patent Application Publication
(10) Pub. No.: US 2023/0149866 A1
(43) Pub. Date: May 18, 2023

(54) WET ATOMIZATION APPARATUS AND METHOD

(71) Applicants: YOSHIDA WORKS PRO Co., Ltd., Tokyo (JP); National lnstitute of Advanced Industrial Science and Technology, Tokyo (JP)

(72) Inventors: Satoshi YOSHIDA, Tokyo (JP); Satoru YOSHIDA, Tokyo (JP); Haruhisa KATO, Ibaraki (JP); Ayako NAKAMURA, Ibaraki (JP)

(21) Appl. No.: 17/907,585

(22) PCT Filed: Mar. 25, 2021
(86) PCT No.: PCT/JP2021/012467

§ 371 Date: Sep. 28, 2022

(30) Foreign Application Priority Data
Apr. 2, 2022 (JP) 2020-066887

(51) Int. Cl. B01F 31/65; B01F 35/222

(52) U.S. Cl. CPC B01F 31/651; B01F 35/222

(57) ABSTRACT

A wet atomization apparatus includes: a process-target fluid storing container for storing the process-target fluid; a syringe including a gasket configured to be slid on an inner peripheral wall of the syringe by a plunger; a thin tube having one end inserted in the process-target fluid storing container and another end connected to the syringe; and a control section that performs control of the plunger to move forward and backward. Under the control by the control section, an atomization process is performed at least once in which the plunger is moved backward to allow the process-target fluid in the process-target fluid storing container to flow into the syringe via the thin tube so as to be stored in the syringe and the plunger is moved forward to return the process-target fluid stored in the syringe into the process-target fluid storing container via the thin tube.

### TECHNICAL FIELD

The present invention relates to a wet atomization apparatus and a wet atomization method both for atomizing particles contained in a fluid to be processed (herein also referred to as “process-target fluid”). More specifically, the present invention relates to a wet atomization apparatus and a wet atomization method both capable of advanced atomization of particles contained in a process-target fluid by a simple process of moving the process-target fluid forward and backward in a thin tube.

### BACKGROUND ART

A conventional apparatus equipped with a wet jet mill processing section as described in Patent Literature (hereinafter, referred to as PTL) 1 is known. The wet jet mill processing section ejects a process-target fluid, in which the particles are contained, from one or two nozzles at ultra-high pressure, thereby atomizing the particles contained in the process-target fluid.

PTL 1 describes a slurry producing apparatus in which a following process is performed: a slurry precursor formed in mixing tank 11 by mixing a solvent and powder is discharged from mixing tank 11 by liquid supply pump 13; the slurry precursor is pressurized to have a pressure of, for example, 10 MPa or more by pressure booster 14, and is ejected into collision unit (wet jet mill processing section) 15; after subjected to a wet jet mill treatment in the unit, the slurry precursor is introduced into mixing tank 11 by circulation pump (circulation section) 17; and a small amount of powder is mixed into the slurry precursor in mixing tank 11. By repeating the above process a predetermined number of times, a slurry having a desired powder concentration is produced, and then valve 18 is switched to guide the produced slurry to slurry tank 19.

### CITATION LIST

### Patent Literature

PTL 1
Japanese Patent Application Laid-Open No. 2010-77001

### SUMMARY OF INVENTION

### Technical Problem

The slurry producing apparatus described in PTL 1 have the following problems. In addition to the use of two pumps, liquid supply pump 13 and circulation pump 17, provision of pressure booster 14 after liquid supply pump 13 is necessary; further, the provision of mixing tank 11 for mixing a solvent and powder and slurry tank 19 for receiving the produced slurry at different positions is also necessary. As a result, the apparatus becomes large and expensive, and as a slurry precursor is ejected by using liquid supply pump 13 and pressure booster 14, advanced atomization with the use of the slurry producing apparatus is difficult.

The present invention has been made to solve such problems, and an object of the present invention is to provide a wet atomization apparatus, with a reduced size and a simple structure, and a wet atomization method both capable of advanced atomization of particles contained in a process-target fluid.

### Solution to Problem

To achieve the above object, the invention of claim 1 is configured as a wet atomization apparatus for atomizing particles contained in a process-target fluid. The wet atomization apparatus includes a process-target fluid storing container for storing the process-target fluid; a syringe including a gasket configured to be slid on an inner peripheral wall of the syringe by a plunger; a thin tube having one end inserted in the process-target fluid storing container and another end connected to the syringe; and a control section that performs control of the plunger to move forward and backward, wherein under the control by the control section, an atomization process is performed at least once in which the plunger is moved backward to allow the process-target fluid in the process-target fluid storing container to flow into the syringe via the thin tube so as to be stored in the syringe and the plunger is moved forward to return the process-target fluid stored in the syringe into the process-target fluid storing container via the thin tube.

In the invention of claim 1, the invention of claim 2 is configured such that the thin tube is detachably connected to the syringe.

In the invention of claim 1 or 2, the invention of claim 3 is configured such that a diameter of the thin tube is determined according to the particle size of the particles contained in the fluid process-target fluid.

In the invention of claim 1 or 2, the invention of claim 4 is configured such that a length of the thin tube is determined according to the particle size of the particles contained in the process-target fluid and a desired atomization degree.

In the invention of any one of claims 1 to 4, the invention of claim 5 is configured such that the control section controls a speed of the process-target fluid extruded via the thin tube by the plunger in such a way that the flow of the process-target fluid in the thin tube becomes turbulent, and controls the number of times the atomization process is performed by a reciprocating operation of the plunger to a predetermined number of times.

The invention of claim 6 is configured as a wet atomization method for atomizing particles contained in a process-target fluid. The wet atomization method includes: inserting one end of a thin tube into a process-target fluid storing container for storing the process-target fluid; connecting another end of the thin tube to a syringe including a gasket configured to be slid on an inner peripheral wall of the syringe by a plunger; and performing an atomization process at least once in which the plunger is moved backward to allow the process-target fluid in the process-target fluid storing container to flow into the syringe via the thin tube so as to be stored in the syringe and the plunger is moved forward to return the process-target fluid stored in the syringe into the process-target fluid storing container via the thin tube.

In the invention of claim 6, the invention of claim 7 is configured such that the thin tube is detachably connected to the syringe.

In the invention of claim 6 or 7, the invention of claim 8 is configured such that a diameter of the thin tube is determined according to the particle size of the particles contained in the fluid process-target fluid.

In the invention of claim 6 or 7, the invention of claim 9 is configured such that a length of the thin tube is determined according to the particle size of the particles contained in the process-target fluid and a desired atomization degree.

In the invention of any one of claims 6 to 9, the invention of claim 10 is configured such that a speed of the process-target fluid extruded via the thin tube by the plunger is controlled in such a way that a flow of the process-target fluid in the thin tube becomes turbulent, and the number of times the atomization process is performed by a reciprocating operation of the plunger is controlled to a predetermined number of times.

### Advantageous Effects of Invention

The present invention is configured as a wet atomization apparatus for atomizing particles contained in a process-target fluid. The wet atomization apparatus includes a process-target fluid storing container for storing the process-target fluid; a syringe including a gasket configured to be slid on an inner peripheral wall of the syringe by a plunger; a thin tube with one end inserted in the process-target fluid storing container and the other end connected to the syringe; and a control section that performs control of the plunger to move forward and backward. In the wet atomization apparatus, an atomization process is performed at least once, and in the atomization process, by the control performed by the control section, the plunger is moved backward to allow the process-target fluid in the process-target fluid storing container to flow into the syringe via the thin tube so as to be stored in the syringe, and the plunger is moved forward to return the process-target fluid stored in the syringe into the process-target fluid storing container via the thin tube. Therefore, the invention has the effects that allows the provision of a wet atomization apparatus, with a reduced size and a simple structure, and a wet atomization method both capable of advanced atomization of particles contained in a process-target fluid.

### BRIEF DESCRIPTION OF DRAWINGS

FIG. 1 is a side view of a wet atomization apparatus of an example according to the present invention;

FIG. 2 is a front view of the wet atomization apparatus illustrated in FIG. 1;

FIG. 3 is a side view of the wet atomization apparatus illustrated in FIG. 1 at the start of its operation;

FIGS. 4A to 4C are diagrams explaining the operation of the wet atomization apparatus illustrated in FIG. 1;

FIGS. 5A and 5B are diagrams explaining the operating principle of the wet atomization apparatus illustrated in FIG. 1;

FIG. 6 is a flowchart explaining an exemplary operation of the wet atomization apparatus according to the present invention; and

FIG. 7 is a graph in which the decrease of the particle size (size/nm) with respect to the number of times (step number) the atomization process is performed by the forward and backward movement control of actuator 23 is plotted with the use of thin tube 30 having a diameter of 0.762 mm and a length of 65 cm, and of calcium carbonate particles/SOFTANOL aqueous solution having a calcium carbonate concentration of 0.1 mg/ml and a SOFTANOL concentration of 0.05 mg/ml as a process-target fluid.

### DESCRIPTION OF EMBODIMENTS

Hereinafter, at least one example of the present invention will be described in detail with reference to the drawings attached to the application.

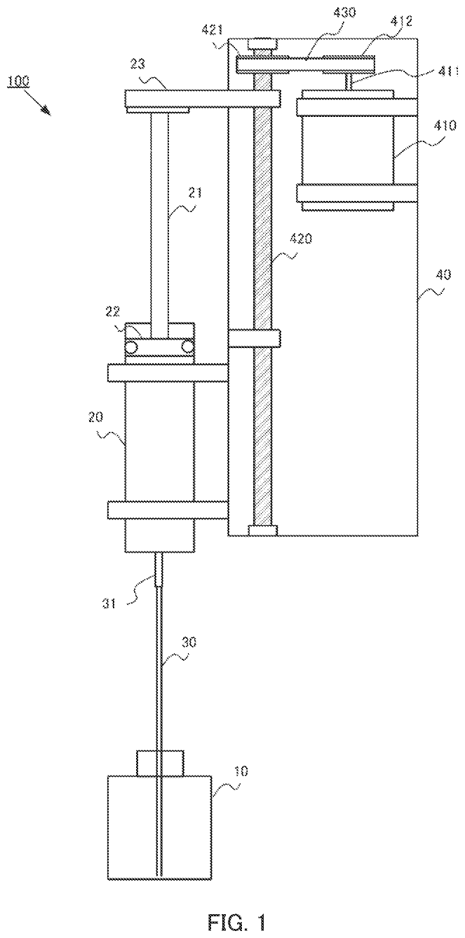

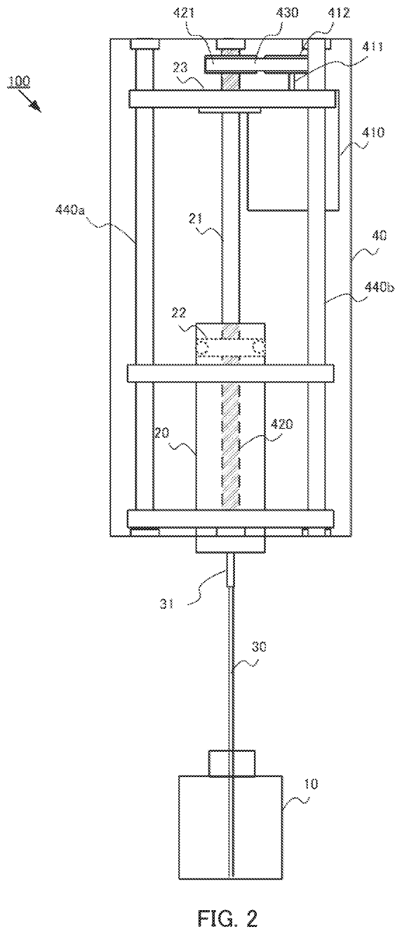

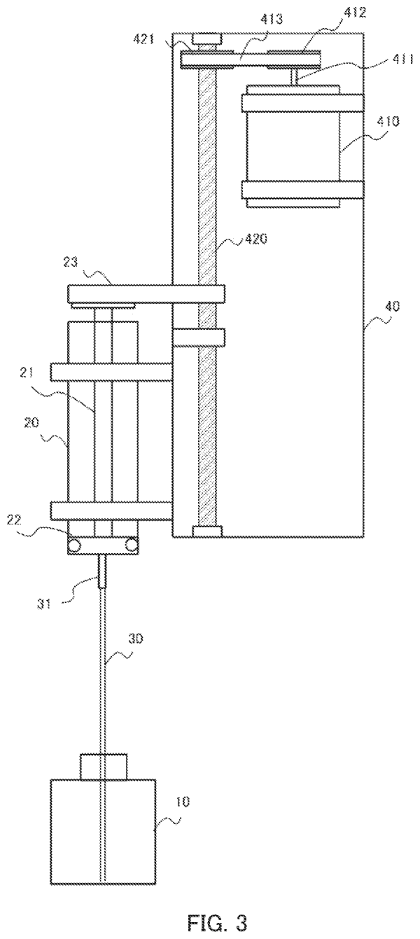

FIG. 1 is a side view of a wet atomization apparatus of an example according to the present invention. FIG. 2 is a front view of the wet atomization apparatus illustrated in FIG. 1. FIG. 3 is a side view of the wet atomization apparatus illustrated in FIG. 1 at the start of its operation.

Wet atomization apparatus 100 of the present example in FIGS. 1 to 3 atomizes the particles contained in a process-target fluid stored in process-target fluid storing container 10. Wet atomization apparatus 100 can be used alone, but can also be used, for example, as a particle atomization apparatus before a well-known jet mill.

Syringe 20 includes gasket 22 that slides on the inner peripheral wall of the syringe. Gasket 22 is operated so as to be slid forward and backward by plunger 21 connected to gasket 22.

Thin tube 30 is detachably connected to one end of syringe 20 via adapter 31. The distal end of thin tube 30 is inserted into process-target fluid storing container 10 as illustrated in FIGS. 1 to 3 when a process-target fluid stored in the process-target fluid storing container 10 is subjected to an atomization process.

One end of plunger 21, which moves gasket 22 forward and backward, is connected to gasket 22, and the other end of plunger 21 is connected to actuator 23 that is controlled to move forward and backward by ball screw 420 of control section 40.

Ball screw 420 is driven by motor 410. That is, first pulley 412 is attached to rotating shaft 411 of motor 410, and second pulley 421 is attached to one end of ball screw 420. Belt 430 is contained between first pulley 412 and second pulley 421.

As illustrated in FIG. 2, two linear guides 440a and 440b for guiding actuator 23 are respectively provided on both sides of ball screw 420.

When motor 410 rotates in the normal direction, the rotation of motor 410 is transmitted to ball screw 420 via first pulley 412, belt 430, and second pulley 421. The resulting normal rotation of ball screw 420 causes actuator 23 to move downward, and plunger 21 pushes gasket 22 in syringe 20 downward accordingly, moving gasket 22 forward in syringe 20.

When motor 410 rotates in the reverse direction, the rotation of motor 410 is transmitted to ball screw 420 via first pulley 412, belt 430, and second pulley 421. The resulting reverse rotation of ball screw 420 causes actuator 23 to move upward, and plunger 21 moves gasket 22 in syringe 20 upward accordingly, moving gasket 22 backward in syringe 20.

As described above, thin tube 30 is connected to one end of syringe 20, and the distal end of thin tube 30 is inserted in process-target fluid storing container 10. Therefore, when gasket 22 moves backward in syringe 20 due to the upward movement of actuator 23, a process-target fluid in process-target fluid storing container 10 is introduced into syringe 20 via thin tube 30. FIGS. 1 and 2 illustrate this state.

From this state, when actuator 23 moves downward to push gasket 22 down in syringe 20, the process-target fluid in gasket 22 flows through thin tube 30 at a predetermined speed and returns into process-target fluid storing container 10.

In wet atomization apparatus 100 of the present example, particles contained in a process-target fluid stored in process-target fluid storing container 10 are atomized by utilizing the flow of the process-target fluid in thin tube 30 caused by the forward movement of gasket 22 in syringe 20.

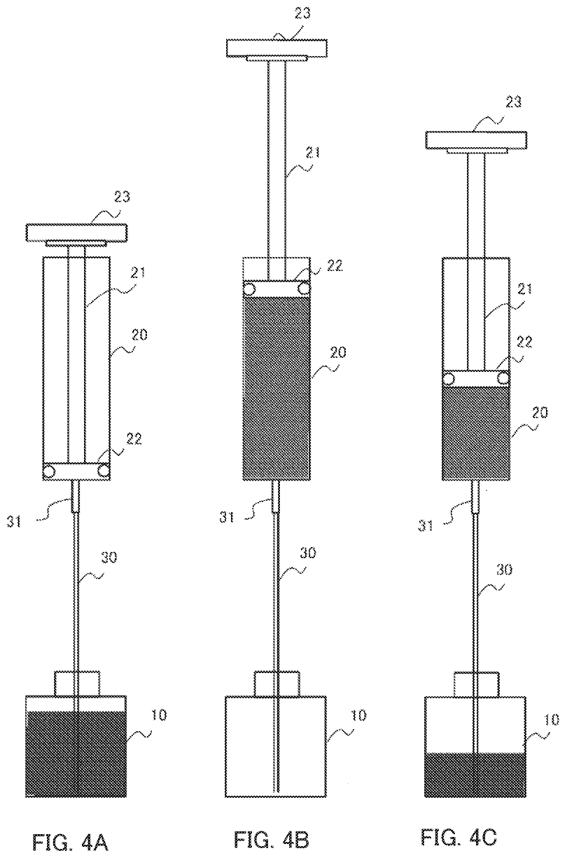

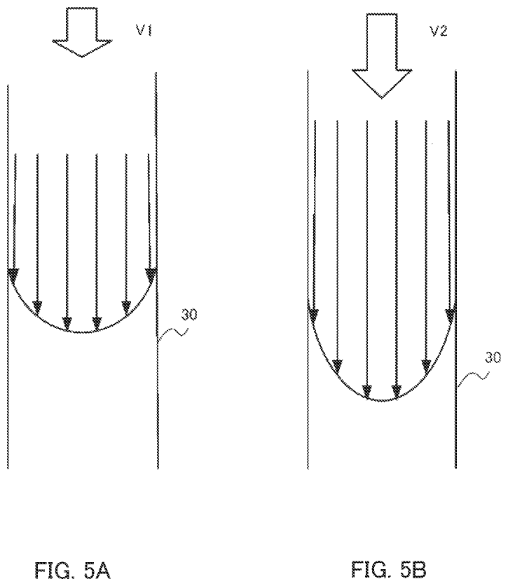

Next, the details of the atomization process will be described with reference to FIGS. 4A to 5B.

As described above, wet atomization apparatus 100 of the present example performs the atomization process with the use of syringe 20. In the atomization process, particles contained in a process-target fluid stored in process-target fluid storing container 10 are atomized by utilizing the flow of the process-target fluid formed in thin tube 30.

FIGS. 4A to 4C are diagrams explaining the operation of the wet atomization apparatus illustrated in FIG. 1. FIGS. 5A and 5B are diagrams explaining the operating principle of the wet atomization apparatus illustrated in FIG. 1.

FIG. 4A illustrates the state of syringe 20 at the start of the atomization process. In the state illustrated in FIG. 4A, the process-target fluid is stored in process-target fluid storing container 10.

From this state, when actuator 23 is moved upward to move gasket 22 in syringe 20 backward, the process-target fluid in process-target fluid storing container 10 passes through thin tube 30 to move into syringe 20 as illustrated in FIG. 4B.

When actuator 23 is then moved downward to move gasket 22 in syringe 20 forward, the process-target fluid in syringe 20 is introduced into thin tube 30 and forms a flow of the process-target fluid in thin tube 30 as illustrated in FIG. 4C.

FIGS. 5A and 5B schematically illustrate the velocity distribution of the flow of a process-target fluid formed in thin tube 30. FIG. 5A illustrates the case of V1 in which the flow of the process-target fluid in thin tube 30 is relatively slow, and FIG. 5B illustrates the case of V2 in which the flow of the process-target fluid in thin tube 30 is relatively fast.

As is clear from FIG. 5A, the speed difference between the part near the side wall of thin tube 30 and the central part of thin tube 30 is not large in the case of V1 in which the flow of the process-target fluid in thin tube 30 is relatively slow. In this case, the flow of the process-target fluid in thin tube 30 is considered to be a laminar flow. On the other hand, as illustrated in FIG. 5B, the speed difference between the part near the side wall of thin tube 30 and the central part of thin tube 30 increases in the case of V2 in which the flow of the process-target fluid in thin tube 30 is relatively fast. In this case, the flow of the process-target fluid in thin tube 30 is considered to be a turbulent flow.

When the flow of the process-target fluid in thin tube 30 becomes turbulent, the probability of collision between particles contained in the process-target fluid in thin tube 30 increases dramatically, possibly enabling highly efficient atomization of the particles contained in the process-target fluid in thin tube 30.

When actuator 23 reaches the lower limit position, that is, the state illustrated in FIG. 4A, one atomization process is completed. This atomization process is repeated until a desired satisfactory atomization degree is obtained.

The diameter of thin tube 30 should be set according to the diameter of the particles contained in a process-target fluid in order to enable highly efficient atomization of the particles in thin tube 30.

The diameter of thin tube 30 should be set to a diameter smaller than the maximum diameter of the particles contained in the process-target fluid in order to enable highly efficient atomization of the particles in thin tube 30.

As for the length of thin tube 30, it is considered that the longer the length of thin tube 30 becomes, the higher the efficiency of atomization of the particles in thin tube 30 becomes. It is thus preferable to determine the length according to the diameter of the particles and the desired atomization degree.

There are also an optimum speed of flow of the process-target fluid in thin tube 30 and an optimum number of times the atomization process is performed in order to enable highly efficient atomization of particles contained in the process-target fluid in thin tube 30.

For the highly efficient atomization, the wet atomization apparatus of the present invention employs the following configurations.

1) As thin tubes 30, a plurality of thin tubes is prepared according to the particle size of particles contained in the process-target fluid, which is to be stored in process-target fluid storing container 10, and adapter 31 is used for detachably connecting these thin tubes to syringe 20 individually.

2) The diameter of thin tube 30 to be connected to syringe 20 is determined according to the particle size of the particles contained in the process-target fluid.

3) The length of thin tube 30 to be connected to syringe 20 is determined according to the particle size of the particles contained in the process-target fluid and the desired atomization degree.

4) The flow velocity of the process-target fluid flowing in thin tube 30 is controlled in such a way that the flow of the process-target fluid becomes turbulent.

5) The number of times the atomization process is performed by the forward and backward movement of gasket 22 in syringe 20 is controlled to a predetermined number of times according to the desired atomization degree.

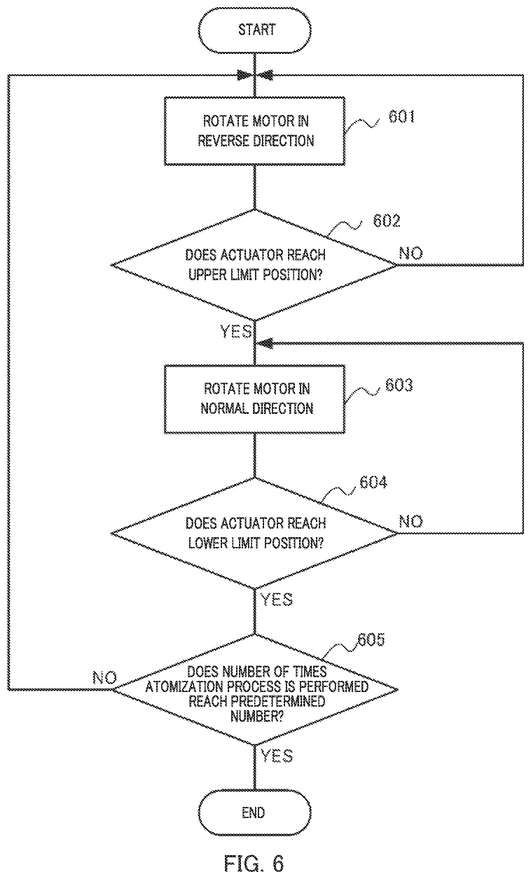

FIG. 6 is a flowchart explaining an exemplary operation of the wet atomization apparatus according to the present invention.

In FIG. 6, from the state illustrated in FIG. 4A, which is the starting point of the atomization process according to the present invention, motor 410 is rotated in the reverse direction (step 601). Due to the reverse rotation of motor 410, actuator 23 moves upward, and accordingly, plunger 21 moves gasket 22 in syringe 20 upward, that is, gasket 22 is moved backward in syringe 20. As a result, the process-target fluid in process-target fluid storing container 10 is introduced into syringe 20 through thin tube 30.

Whether or not actuator 23 reaches the upper limit position is then checked (step 602), and when actuator 23 does not reach the upper limit position (NO in step 602), the processing returns to step 601 and the reverse rotation of motor 410 is continued.

When it is determined in step 602 that actuator 23 reaches the upper limit position, that is, reaches the state illustrated in FIG. 4B (YES in step 602), motor 410 is controlled to rotate in the normal direction (step 603). Due to the control of motor 410 to rotate in the normal direction, actuator 23 moves downward to push gasket 22 down in syringe 20, that is, in the state illustrated in FIG. 4C. From this state, the process-target fluid in gasket 22 is returned into process-target fluid storing container 10 at a predetermined speed through thin tube 30, thereby atomizing the particles contained in the process-target fluid.

Whether or not actuator 23 reaches the lower limit position is then checked (step 604), and when actuator 23 does not reach the lower limit position (NO in step 604), the processing returns to step 603 and the normal rotation of motor 410 is continued. When it is determined in step 604 that actuator 23 reaches the lower limit position, that is, reaches the state illustrated in FIG. 4A (YES in step 604), then checked is whether or not the number of times the atomization process is performed by the control of actuator 23 to move forward and backward (herein also simply referred to as “forward and backward movement control of actuator 23”) reaches a predetermined number (set value) set in advance (step 605).

When the number of times the atomization process is performed by the forward and backward movement control of actuator 23 does not reach the predetermined set value set in advance (NO in step 605), the processing returns to step 601, and the processing from steps 601 to 605 is repeated. When it is determined in step 605 that the number of times the atomization process is performed by the forward and backward movement control of actuator 23 reaches the predetermined set value set in advance (YES in step 605), the atomization process is terminated.

In the following, an example of actual atomization of particles by the above-described atomization processing method will be described.

In the present example, the atomization process of calcium carbonate particles is performed with the use of thin tube 30 having a diameter of 0.762 mm and a length of 65 cm, and of calcium carbonate particles/SOFTANOL aqueous solution having a calcium carbonate concentration of 0.1 mg/ml and a SOFTANOL concentration of 0.05 mg/ml as a process-target fluid.

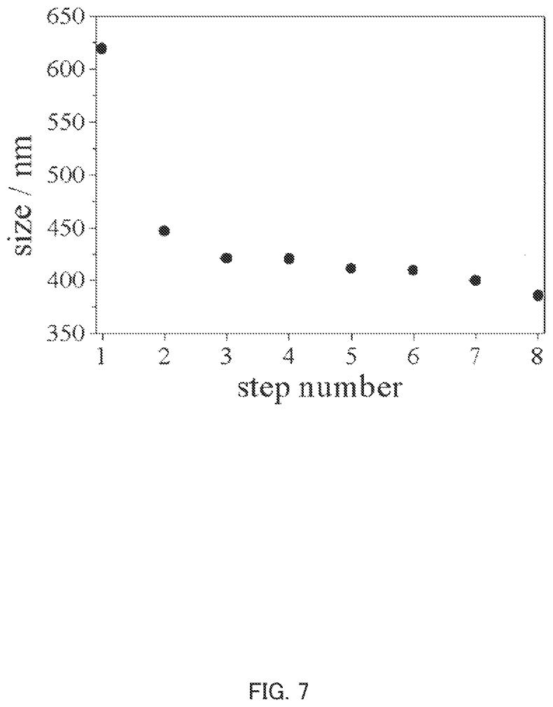

FIG. 7 is a graph in which the decrease of the particle size (size/nm) with respect to the number of times (step number) the atomization process is performed by the forward and backward movement control of actuator 23 is plotted.

FIG. 7 clearly shows that the particle size (size/nm) gradually decreases as the number of times (step number) the atomization process is performed by the forward and backward movement control of actuator 23 increases.

In the above embodiment, a configuration of a single syringe system with one syringe is used. Such a configuration may employ a double syringe system with two syringes or a multi-syringe system with three or more syringes.

The reasons for employing the double syringe system or a multi-syringe system are as follows: with a single syringe, atomization may take longer time when the amount of process-target fluid is large; and when the particle size of particles contained in the process-target fluid is large, it is necessary to replace the thin tube with another thin tube having a different diameter and length for the desired atomization.

Employing the double syringe system or a multi-syringe system can shorten the time for the desired atomization of the process-target fluid. In addition, in the configuration in which two or more syringes connecting thin tubes of different diameters and lengths are provided, and the atomization process is performed by alternately using the plurality of syringes, continuously performing of the atomization process becomes possible without replacing the thin tube.

One example of the present invention is described above; however, the present invention is not limited to the above-described example. Within the scope of the technical idea of the present invention, many modifications are possible from ordinary creative ability of a person skilled in the art.

### REFERENCE SIGNS LIST

10 Process-target fluid storing container
20 Syringe
21 Plunger
22 Gasket
23 Actuator
30 Thin tube
31 Adapter
32 Second pulley
33 Nut part
40 Control section
410 Motor
411 Rotating shaft
412 First pulley
420 Ball screw
421 Second pulley
430 Belt
440a, 440b Linear guide
100 Wet atomization apparatus

1. A wet atomization apparatus for atomizing particles contained in a process-target fluid, the wet atomization apparatus comprising:
a process-target fluid storing container for storing the process-target fluid;
a syringe including a gasket configured to be slid on an inner peripheral wall of the syringe by a plunger;
a thin tube having one end inserted in the process-target fluid storing container and another end connected to the syringe; and
a control section that performs control of the plunger to move forward and backward,
wherein
under the control by the control section, an atomization process is performed at least once in which the plunger is moved backward to allow the process-target fluid in the process-target fluid storing container to flow into the syringe via the thin tube so as to be stored in the syringe and the plunger is moved forward to return the process-target fluid stored in the syringe into the process-target fluid storing container via the thin tube.

2. The wet atomization apparatus according to claim 1, wherein:
the thin tube is detachably connected to the syringe.

3. The wet atomization apparatus according to claim 1, wherein:
a diameter of the thin tube is determined according to a particle size of the particles contained in the fluid process-target fluid.

4. The wet atomization apparatus according to claim 1, wherein:
a length of the thin tube is determined according to a particle size of the particles contained in the process-target fluid and a desired atomization degree.

5. The wet atomization apparatus according to claim 1, wherein:
the control section controls a speed of the process-target fluid extruded through the thin tube by the plunger in such a way that a flow of the process-target fluid in the thin tube becomes turbulent, and controls the number of times the atomization process is performed by a reciprocating operation of the plunger to a predetermined number of times.

6. A wet atomization method for atomizing particles contained in a process-target fluid, the wet atomization method comprising:
inserting one end of a thin tube into a process-target fluid storing container for storing the process-target fluid;
connecting another end of the thin tube to a syringe including a gasket configured to be slid on an inner peripheral wall of the syringe by a plunger; and
performing an atomization process at least once in which the plunger is moved backward to allow the process-target fluid in the process-target fluid storing container to flow into the syringe via the thin tube so as to be stored in the syringe and the plunger is moved forward to return the process-target fluid stored in the syringe into the process-target fluid storing container via the thin tube.

7. The wet atomization method according to claim 6, wherein:
the thin tube is detachably connected to the syringe.

8. The wet atomization method according to claim 6, wherein:
a diameter of the thin tube is determined according to a particle size of the particles contained in the fluid process-target fluid.

9. The wet atomization method according to claim 6, wherein:
a length of the thin tube is determined according to a particle size of the particles contained in the process-target fluid and a desired atomization degree.

10. The wet atomization method according to claim 6, wherein: a speed of the process-target fluid extruded via the thin tube by the plunger is controlled in such a way that a flow of the process-target fluid in the thin tube becomes turbulent, and the number of times the atomization process is performed by a reciprocating operation of the plunger is controlled to a predetermined number of times.
